(19) United States
(12) Patent Application Publication
(10) Pub. No.: US 2006/0271974 A1
(43) Pub. Date: Nov. 30, 2006

(54) Multi-tiered content management system

(76) Inventors: Robert C. Gaydos JR., Harleysville, PA (US); Phillip A. Gabler, Doylestown, PA (US); Fred J. Allegrezza, Hatfield, PA (US); Douglas R. Luehrs, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 11/497,639

(22) Filed: Aug. 2, 2006

Related U.S. Application Data
(62) Division of application No. 10/393,521, filed on Mar. 19, 2003.

(51) Int. Cl. H04N 7/173; H04N 7/16

(52) U.S. Cl. 725/86; 725/89; 725/102; 725/87; 725/134; 725/142; 725/25

(57) ABSTRACT

A video on demand (VOD) system (100) for use in a distributed network environment. The distributed network environment contains a number of geographic networks (400A-400N) that are divided into a plurality of tiers (305-1 to 305-N), which are allocated to content providers (225). A content provider (225) provides content to the network with a tier assignment. The content is received pursuant to the assigned tier. Identification information, such as Categorization Information, is provided with and/or associated with a content file. The identification information may be updated at any time, independently of the content.

### BACKGROUND OF THE INVENTION

1. Field of the Invention

The present invention relates to the field of video-on-demand servers and systems and content management for video-on-demand servers.

2. Description of the Related Art

Delivery of client selected video content directly to a subscriber at a time chosen by the subscriber via a cable TV or other distribution network is a fast growing segment of the entertainment industry known as Video-on-Demand or VOD. The industry is enabled by new technology but sales are driven by the availability of up-to-date content demanded by consumers.

With increasing demand for VOD services, network operators and content providers are faced with difficult challenges. Networks have a finite storage capacity dependent upon the capacity of video servers distributed throughout the network. The storage capacity varies by location based upon the number of subscribers, subscriber characteristics, network characteristics, etc. Thus, a network with smaller capacity servers cannot store as much content as a network with larger capacity servers, and therefore less content can be made available on certain networks. Although storage capacity can be expanded, such expansion imposes additional costs to the network operator. Thus, cost effective storage capacity varies by location based on factors associated with each network.

Several content providers provide content to the network operator for storage on the VOD servers. The content providers must negotiate with the network operators or multiple system operators (“MSOs”) and attempt to maximize revenue by providing the best content mix to the limited storage capacity available. Likewise, the network operator must negotiate and maintain service contracts with multiple classes of content providers, such as broadcasters, advertisers, etc., wherein there are several content providers within each class. Thus, the allotment of storage space on VOD servers is currently a detailed and complex manual task for both the network operator and the content providers. The difficulty is enhanced by the fact that each network operator must deal with multiple content providers and vice versa for multiple networks having different storage capacities and potentially different customer preferences. Currently, the cost of performing detailed allocation and product content planning across the many variables negatively impacts any additional revenue produced. Thus, there is a need for a system and method by which network operators and content providers can easily and efficiently allocate storage space for content.

Another problem is the categorization of content. Typically this is a static process whereby each piece of content received by a network contains identification information. In the cable field, this information is called “meta-data”. The identification information includes a summary of the content, the actors, rating, and type of content. Additionally, the content provider, MSO or network operator may add information such as pricing, time of availability, packaging, and the like (“Categorization Information”) to the identification information. Although much of the identification information never changes, the Categorization Information may change in accordance with some factor, such as the age of the content. For example, a new release movie may cost $5, but after 30 days the movie may no longer be considered a new release and, thus, may be priced at $3. Or, initially a piece of content may be offered on the weekdays only, but after 45 days may be available 7 days a week. Or, initially the content may only be available to preferred customers only, but after 15 days it may be available to all customers. Currently, all the identification information is static and, thus, cannot be changed unless the content is reloaded onto the system. However, reloading the content places a burden on the system and is costly, especially if the primary desire is to simply re-categorize the content. Thus, there is a need to allow for changes to the Categorization Information by the content provider, network operator, or MSO, as appropriate, with or without re-sending the content.

### SUMMARY OF THE INVENTION

The present invention provides several advantageous methods, which may be used alone or in conjunction with one or more others. One method manages the receipt of content by a Video On Demand (VOD) system within a network. The method includes defining a plurality of tiers within the network, each tier having a respective storage capacity, allocating each tier to a content provider, receiving content, and a tier assignment for the content, and storing the content on the network in the assigned tier.

Another method provides content for a Video On Demand (VOD) system within a network, with the network having a plurality of tiers, and with each tier having a respective storage space. The method includes receiving, from a content provider, content to be provided on the network and first identification information for the content, where the identification information includes a tier assignment, providing the content on the system in accordance with the first identification information, receiving second identification information for the content but without receiving the content again, and providing the content on the network in accordance with the second identification information.

Still another method manages the content of a Video On Demand (VOD) network. The method includes providing content, and first identification information for the content, to the VOD network, and providing second identification information for the content to the VOD network but without providing the content again.

Still another method manages allocation of storage of a Video on Demand (VOD) network. The method includes defining a plurality of tiers for the VOD network, each tier having a predetermined ranking, storing content on the VOD network in accordance with a tier assignment, monitoring the demand for the content, and modifying the tier assignment for the content in accordance with the demand.

Still another method manages the content on a Video On Demand (VOD) system for use within a network. The method includes receiving content and placing the content on the system, receiving a request from a requestor to add new content on the system, determining whether space is available for the new content, if space is available then placing the new content on the system, and if space is not available then notifying the requestor that the new content will not be placed on the system.

Still another method manages information related to content on a network. The method includes adding Categorization Information to the identification information associated with the content, maintaining the identification information, including the Categorization Information, in a database associated with the network, and changing the Categorization Information for the content.

Various modifications, variations, and improvements to these methods are also provided by the present invention.

The present invention provides a system and method to manage allocation of VOD server storage capacity. In one aspect of the invention a tier-based algorithm is implemented that allows each of multiple content providers to control their product content within their allocated space multiple content providers in a manner that accommodates different storage capacities for different networks. Network content is loaded and maintained consistent with the tier based algorithm such that the maximum available content is utilized consistent with the network operator space allocations and content provider program content allocation decisions.

The system also provides reports to the network operator and content providers so that they may effectively manage their areas of responsibility for mutual benefit.

The present invention also provides a priority based allocation algorithm which can automatically provide many of the same benefits.

The present invention provides a system and method by which a network operator procures content from content providers in multiple tiers; the content can then be allocated appropriately according to space available on the network. This ‘tier approach’ provides the network operator with a tool to make sure all content will fit into a defined space on the network. As content files, such as movies, advertisements, etc., are added or deleted, the system automatically allocates the space available so that it always remains within the tier space limitations. The network operator can then manage the content. In accordance with the invention, software acts as a filter to ensure the system only accepts content that fits into the specific space or tier allocations within a network.

The present invention also provides for alteration of the identification information, such as the Categorization Information, with or without reloading the content. This may be used to impact pricing, planning, timing and content availability in a manner to optimize revenue independent of server capacity across multiple servers within one network or across multiple network operators.

The present invention also provides a server storage allocation tool subsystem utilized by the network operator in planning and maintaining server space allocations into various use categories and content providers for each server in the video on demand system.

The present invention also provides a content loading and filtering subsystem that manages the program content on each video on demand server in compliance with selections made by the content providers and network operators in the program content allocation subsystem and server storage allocation subsystem.

The present inventions also provides for providing a plurality of menus based upon different Categorization Information items so that the menu presented to a subscriber is responsive to such factors as the subscriber's location, the time of day or day of week that the content is desired, previous purchases, etc.

Finally, the identification information attached to the content may change or be changed over time so that content offerings may be effectively and dynamically managed.

### BRIEF DESCRIPTION OF THE DRAWINGS

FIG. 1 illustrates a Video On Demand system in accordance with the present invention.

FIG. 2 illustrates the Video On Demand system of the present invention in its preferred environment.

FIG. 3 illustrates the tier-based management system of the present invention.

FIG. 4 illustrates the tier-based management system of the present invention with several independent network operators.

FIG. 5 illustrates the security feature of the preferred embodiment of the present invention.

### DETAILED DESCRIPTION OF THE INVENTION

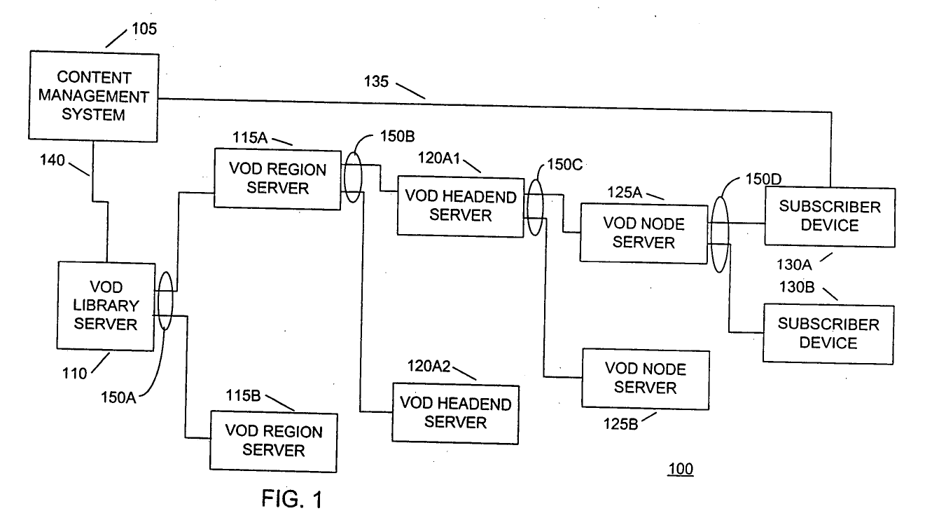

FIG. 1 illustrates a Video On Demand (VOD) system 100 in accordance with the present invention. Servers 110, 115, 120, are capable of storing quantities of data, including but not limited to video content and other types of content. In the exemplary embodiment, these servers are video servers and are used to store, manage, and deliver quantities of video in the form of video content files across an interactive network upon the request of a subscriber. The video servers may store the content or the content may be stored on a storage drive coupled to a video server. For ease of description, the term video server as used herein shall include both of these configurations. The interactive network 135, 140, 150 may be any type of network capable of transferring data electronically such as, but not limited to, cable networks, ATM networks, the Internet, wireless networks, Telco networks, satellite networks, or any combination thereof. A subscriber device 130 is a device used by the end-user to specify the desired video content and/or to receive the video content for viewing. The network equipment 105, 110, 115, 120, 125 provides the managing, processing, and modulation, as appropriate, for the delivery of the video content across the network to the subscriber device 130, such as, but not limited to, a set-top-box, personal computer, lap-top, personal digital assistant, cellular phone or the like that is connected to the network. For ease of explanation, this description shall use the terminology for a cable network. However, although the terminology might be different, the invention is easily implemented on other types of networks. Cable networks (and other networks) are typically divided into distinct geographical areas (“Systems”) serving subscribers in the areas. In large regions such as the United States there are typically Multiple System Operators (“MSOs”), each operating multiple Systems. The term “System” generally means a regional network serving a defined area. For example, an “Atlanta System” would serves subscribers in and around the metropolitan area of Atlanta, Ga. Similarly, a “Tampa” System, would serves subscribers in and around metropolitan area of Tampa, Fla.

The VOD servers 115, 120, and 125 within a network or System, may be arranged in a distributed architecture such that multiple video servers are distributed throughout the network transport infrastructure. As shown in FIG. 1, a single large capacity VOD server 110 may serve as a library server. The library server serves content to region VOD servers 115, which serve content to multiple head-end VOD servers 120, which in turn serve content to multiple node VOD servers 125, which in turn supply content to subscriber devices 130. The number of servers located at different locations is by way of example only and may vary depending upon the particular requirements of the network and may include additional VOD servers, such as hub servers between the head end servers and the nodes. Alternatively, the network may call for a centralized storage structure with all the storage located in one location.

As shown in FIG. 1, a Content Management System (CMS) 105 manages the storage of the content files across the network containing the VOD system. It should be understood that FIG. 1 is a functional drawing, not a literal drawing, as the functions reflected may be integrated as part of other specified functions. The CMS 105 is connected to and in communication with the VOD server 110 and it receives, stores and maintains information about the content files. The CMS is capable of receiving and processing up-stream information received from subscribers and stores and maintains such information. Network 150 may be a downstream link or may be a bidirectional link. Likewise, link 135 may be an upstream link or may be a bidirectional link. Thus, the information may be transferred via the network 150 and link 140, or via the link 135, as desired.

Content providers provide content to the VOD system 100 in various formats. For example, the system may receive RF signals by satellite, ATM data over ATM networks, local feeds and other information via terrestrial link. The content is received, processed, and reformatted as necessary. For example content may be received in digitally compressed format and demultiplexed by a demultiplexer and stored in any convenient format or formats, such as MPEG or MPEG2, but the present invention is not limited to these formats. The reformatted content is stored on the VOD servers.

The term “provider” is used broadly herein and is intended to identify any entity, other than the network operator, that has a connection to the network, and can provide input to the network or control the operation of the network.

Although the term “System” is generally understood to mean a regional network serving a defined area, multiple Systems may be interconnected, to allow for providing service to a larger area, to share resources, to provide additional features or benefits, to allow subscribers to make purchases even when away from their local, or “home” System so as to view content while at, for example, a relative's home which is on a different System, etc. Such a “remote purchase” may be authorized, for example, by requiring the subscriber to input a subscriber code number and personal identification number or code. Additionally, a System may also be independent and/or serve only a small area. Thus, a System may be a small, local area network System, a regional network System, a collection or an association of independent Systems, a national network System, an international network System, or a combination of the above. The size of a System is therefore primarily a design choice determined by factors such as geography or terrain, population diversity, jurisdictional issues, cost, etc.

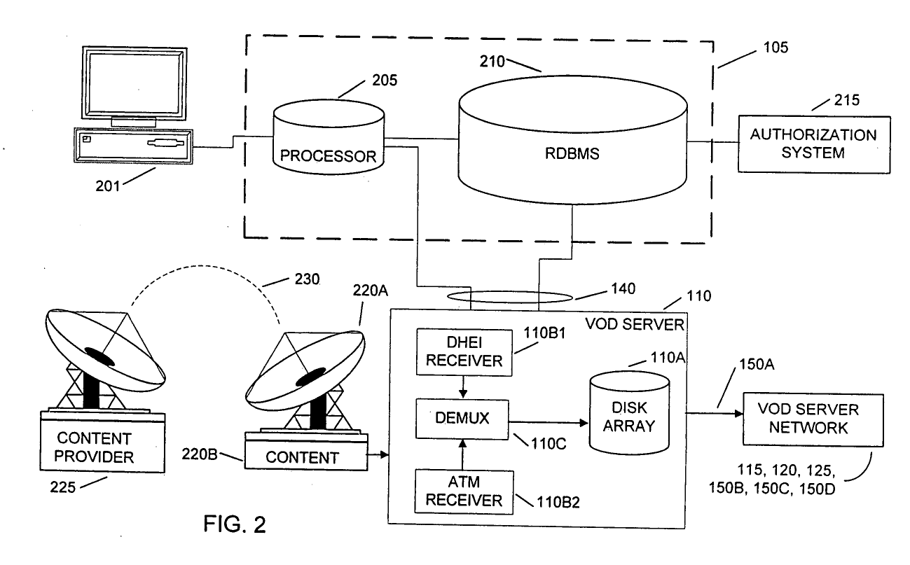

As shown in FIG. 2, a VOD library server 110 may include various components, including: storage means, such as a disk array 110A, which may be a JBOD (just a bunch of disks) or RAID (redundant array of inexpensive disks) with various architectures and interfaces, such as FC-AL (Fibre Channel-Arbitrated Loop) or SSA (Serial Storage Architecture); receivers 110B for receiving content from content providers, such as DHEI (DigiCable Headend Expansion Interface) receivers 110B1 or ATM (Asynchronous Transfer Mode) receivers 110B2; and demodulating and demultiplexing circuitry 110C. Each VOD system 100 typically has a receiver (“Catcher's Mitt”) 220A, 220B to receive content from the content providers. Content transmission from the content providers 225 to the VOD system 100 is often via satellite feed 230, but may be by any desired and appropriate transmission link. It should be understood that FIG. 2 is a functional drawing, not a literal drawing, as the functions reflected may be integrated as part of other specified functions.

The CMS 105 preferably includes a processor 205, such as a CPU or other processing device, and a relational database management system (RDBMS) 210. The RDBMS 210 functions as a server or storage device and has appropriate software and storage devices. The storage devices of the RDBMS 210 contain a listing or table of one or more of the following: the content providers, the subscribers, the servers upon which the content is located, the orders, the purchase history of each subscriber, the content files, identification information related to the content files, and data regarding the usage (demand) of the content. The CMS 105 is connected to a computer terminal 201 whereby a networkoperator can provide the appropriate input data and changes, and can control the operation of the network.

The CMS 105 is also connected to an authorization system 215 which contains information on the features, privileges, benefits, bonuses, space, tiers, etc., available to each subscriber and/or to each content provider. The authorization system 215 may be external to the CMS 105, as shown, or may be included within the CMS 105, such as part of the RDBMS 210. Thus, when a subscriber requests a particular movie, the CMS 105 queries the authorization system 215 to determine whether or not the subscriber is authorized to receive the movie. If so, then the request may be approved. If not, then the request may be denied. Likewise, if a content provider wishes to store a movie, that request may be granted or denied, or may be granted only with certain restrictions, such as with respect to size or location.

The CMS 105 serves as a content asset management system by providing the content provider and the network operator with a system for the allocation of content in accordance with a tier-based algorithm. The CMS 105 allows the network operator to establish and manage content supplied from multiple content providers 225, such as motion picture studios, film distributors, content aggregators, service providers for interactive applications such as electronic commerce, etc. Individual VOD server content is loaded and maintained consistent with the tier-based algorithm such that maximum available content is utilized on all servers consistent with the operator space allocations and content provider program content allocation decisions.

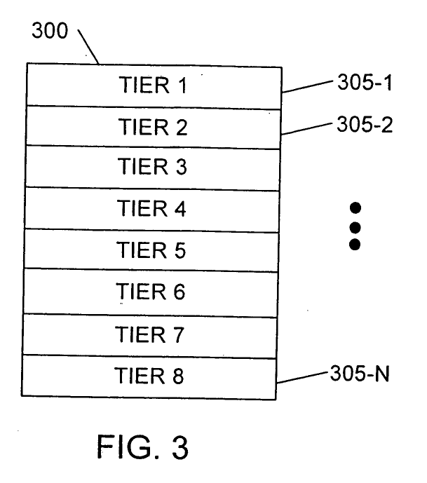

As shown in FIG. 3, the storage capacity 300 of a network is divided into tiers 305-1 to 305-N of storage space. Tiers 305-1 to 305-N may be of various sizes and of any desired size but, preferably, are a standard size, such as the storage required for a number of pieces of content at a standard length in a standard format. For instance, the size of a standard unit may be 100 hours of video in 3 Mbps MPEG2 which would use approximately 13,500 MB of storage space. The video server storage capacity required for a content file depends on the compression format and encoding rates, as well on the number of video streams to be delivered. For example, a content file with MPEG2 content encoded at 6 Mbps will provide higher quality video, but will require more video storage capacity, than a file with MPEG1 content encoded at 1.5 Mbps. It will be appreciated that lower encoding rates provide a lesser quality of video.

A networks's content capacity is divided into storage blocks that are allocated to particular tiers. The tiers 305-1 to 305-N herein described are preferably only for management of content as between the content provider and the network and, therefore, do not necessarily correspond to actual blocks of particular storage locations. Once the content is received it may be managed with respect to the content provider as a block, even though the various content, for example, different movies, from that content provider are, or may be, stored in different physical locations. For instance, in order to obtain the desired storage capacity or redundancy, a VOD region server 115A may comprise fifty or more individual, distinct server devices. Also, it is not necessary that each server device accommodate all of the tiers supported by the region server 115A. For example, one server device might service tiers 1 and 2, another server device might service tiers 1 and 3, still another server device might service tiers 4 and 5, still another server device might service only tier 2, etc. Thus, the tiers may be considered to be virtual tiers in that the content for a tier might be stored in one, two, or more distinct server devices, and a distinct server device might support one, two or more tiers. Therefore, the region server 115A may be a single device, or may be a plurality of devices, with the tiers and the content being spread among the various server devices as might be desired or appropriate.

Data associated with the particular tiers assigned to a content provider 225 are stored as a table in the RDBMS 210 within the CMS 105. For example, the RDBMS 210 may store data relating to the title and type of program, the size of the content file, the date on which the file was loaded on the VOD system or a particular tier, etc. Thus, the CMS 105 keeps track of the content stored on the System by each provider and the associated tier of each content file. The CMS 105 can thus ensure that a content provider stores only content that will fit within the particular tier or tiers assigned to that content provider 225.

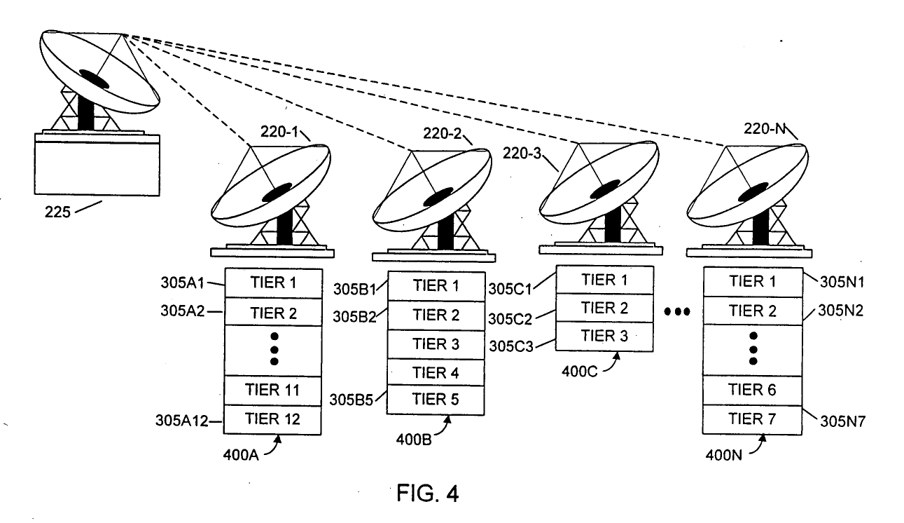

FIG. 4 illustrates the tier-based management system of the present invention with several independent network operators. A content provider 225 may provide content to numerous networks 400A-400N with different content capacities. To increase the flexibility and adaptability of the networks 400A-400N, the networks with higher storage capacities are preferably assigned a greater number of tiers than those with lower storage capacities. Thus, a large capacity network may support multiple tiers of content from each content provider 225, but a small capacity network may only support one tier from each content provider 225. For example, System 400A has twelve tiers 305A1-305A12 of content, System 400B has five tiers 305B1-305B5, System 400C has three tiers 305C1-305C3, and System 400N has seven tiers 305N1-305N7. Tiers for an individual content provider are preferably allocated according to the rule that space for a content provided must be allocated for lower numbered tiers before space for that content provider is allocated to a higher numbered tier. The information associated with the tiers of the content providers is stored in the RDBMS 210.

Each network operator notifies the content provider 225 of, and provides the content provider 225 with, a tier storage amount for one or more tiers, and the time during which this storage amount will be available to the content provider 225. The content provider 225 can then fill these assigned tiers with content files. Because a content provider 225 knows, for each network, the tiers to which it has access, the allotted capacity of each tier, and the time available for use of each tier, the content provider 225 can concentrate on what content to place in what tier at a particular time. For example, the content provider 225 can plan the allocation of its content by specifying content files as belonging to one or more fixed capacity tiers, and then place the content on that/those particular tier(s) at that/those particular time(s), knowing that/those particular tier(s) will be available at that/those particular time(s) on that/those certain network(s), and that other level tiers and/or times will be available as specified, depending upon the individual agreements with the network operators. Subject to these conditions of what space is available on what tier on what network at what time, the content provider 225 is free to develop any allocation strategy or algorithm it may desire.

In the preferred embodiment, a tier may be assigned to only a single provider. Alternatively, a tier may be assigned to two or more different content providers 225, with each content provider 225 having a specified amount of space on that tier.

It is desirable, but not necessary, that a consistent content capacity for each tier of content be available across all network operators so that tier content planning is network operator-independent. It is also desirable, but not necessary, that a consistent capacity for each tier be content provider-independent. Standards for this are expected to be promoted and developed, either formally or de facto. Thus, if such standards are implemented an MSO can plan a tier of content that is compatible across all network operators.

Preferably the CMS 165 has an authorization system that limits access of a given user to only authorized data. For example, the VOD system 100 may require a user identification and password for access to particular data prior to performing user requests. If the user is approved, the CMS 105 will review the request and make sure that it is within proper parameters. For example, a content provider 225 is preferably authorized to view and access only its own tiers and related data.

If authorized, the CMS 105 preferably provides the content provider 225 with the ability to query, sort, and generate reports from the data stored in the RDBMS 210. For example, the content provider 225 may query the RDBMS 210 select and display a current list of content files by tier or in a particular tier, including data such as, file name, content type (movie, documentary, advertisement, etc.), file size, content Categorization Information, the number of requests from subscribers, etc. The content provider 225 can specify which content files are to be added, deleted, or moved. Preferably the content provider 225 is provided with a graphical user interface (GUI) for interacting with the RDBMS 210. The content provider 225 may interact with the CMS 105 in various ways. For example, the content provider 225 may simply replace all of the content on a particular tier allocated to that content provider. The new content may be only slightly changed from that which it replaces but, by replacing the entire tier, the content provider 225 and network operator are more easily able to ascertain the status of the content.

In another example, the content provider 225 may specify which content files are to be added to, moved from, or deleted from, a particular tier. The CMS 105 may provide the content provider 225 with a list of content files currently stored in a particular tier. The content provider 225 may then select one or more files to be deleted or moved from one tier to another. The content provider 225 may also specify one or more files to be added, and into which tier. The CMS 105 will then direct the VOD servers 115, 120, and 125 to perform the requested operations if the requests meet the particular CMS requirements and the content provider has the proper authorization. The CMS 105 can query the content provider's system to request the content if the content does not already reside on a server within the network. Alternatively, the content provider 225 may provide new information associated with the content, such as new identification information for the content, which indicates the proper tier for a particular item of content.

The CMS 105 also preferably includes a security feature that prevents a user (which may be a person, a process, or an entity such as a content provider, MSO, or network operator) from exceeding the allotted storage limits of a particular tier or server. This security feature may be implemented in the processor 205, the RDBMS 210, the authorization system 215, or any combination thereof. Thus, the CMS 105 acts as a filter to prevent the user from loading too much content to a tier's limited storage space. The CMS 105 reviews instructions from the user to insure that the request is within the proper parameters. For example, a content provider 225 may request that a 140-minute movie be added on tier 2 (the content provider's tier) of a network. Upon receipt of this request, the CMS 105 calls up a data table associated with the particular content provider 225. The CMS 105 determines the content files currently stored on tier 2 for the particular content provider and the amount of available storage for that tier. If there is sufficient space available for the new movie, the CMS 105 accepts the request and directs the loading of the movie on the appropriate servers. On the other hand, if there is insufficient space available within in the tier for the movie, the CMS 105 informs the content provider 225 that there is insufficient storage space. For example, the VOD system 100 may display a user message informing the user that there is only 100 minutes of storage space left on tier 2 and that the request to load the movie which is longer than 100 minutes is denied.

The CMS 105 preferably also prompts the user to delete files to make room for the new file, or provides a list of files recommended for removal from that tier to make room for the new file. For example, the VOD system 100 may track the usage of the files and recommend that files with the lowest usage on the tier be deleted, or display combinations of files which, if deleted, would provide sufficient space for the new file. The system may also perform algorithms to determine the best files to delete based upon predetermined or pre-selected variables, such as the usage of the files and their sizes. Any changes entered on the CMS 105 are then synchronized with the content provider 225, and the new content is requested from the content provider 225 if necessary.

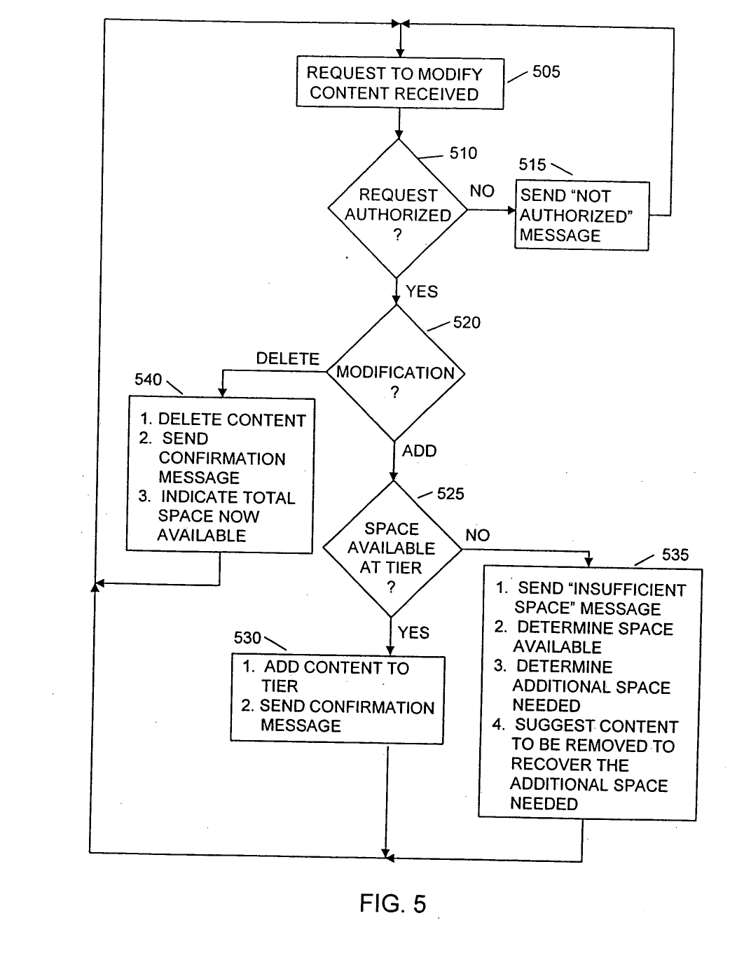

FIG. 5 is a logic flow diagram illustrating the security feature of the preferred embodiment of the present invention. Assume that a user wishes to modify (add content to, or delete content from) a particular tier. At step 505 a request to add content to, or delete content from, a particular tier level is received from the user. Decision 510 determines whether the user making the request is authorized to add or delete content for the specified tier. If not authorized, then a “Not Authorized” message, or a similar message or some other type of message, is preferably sent 515 to the user. If authorized, then decision 520 determines whether the request is to add content or to delete content.

If to add content, decision 525 determines whether space is available at the specified tier for the content. If the space is sufficient, then the content is added 530 to the specified tier. An acknowledgement or confirmation message is also preferably, but not necessarily, sent to the user and/or the network operator. The VOD system 100 may also determine, and advise the user and/or network operator, of the total space now used and/or the remaining space available.

If the space is insufficient, then an “Insufficient Space Available” message of some type is sent 535 to the user. The VOD system 100 may also determine and indicate to the user how much space is available, determine and indicate to the user how much additional space is needed to add the content, and determine and suggest to the user some existing content which is a candidate for removal to recover the additional space. The determination as to which existing content is suggested for removal may be based on any desired criteria, such as the age of the content, the size of the content, the demand for the content, etc. This information is preferably, but not necessarily, sent to both the user and the network operator.

If, at decision 520, the request is to delete content from a particular tier, such as to make more space available for new content, then step 540 deletes the content. The VOD system 100 also preferably, but not necessarily, sends a confirmation that the content has been deleted from that tier, and also determines and advises of the total space now available at that tier for that user.

The CMS 105 also preferably includes a system or process for planning and managing content availability scheduling. For example, the content provider 225 may be provided with a monthly calendar showing the content that will be loaded on that provider's tier(s) by time and date. The content provider 225 may then denote the start and end times for the loading of particular content files on one of its tiers. For example, a content provider 225 may specify that a first movie be loaded on tier 3 on the first day of a month and that the movie be removed on the 15th day of the month. The reason for removal, which need not be provided, may be that the movie is to be replaced by a sequel to the movie. This may be performed in the same manner as for adding or deleting content as shown in FIG. 5. However, in this case, the space available would be determined based upon the “add content” date. That is, the system would access a postdated (future) request file to determine any relevant (content provider 225, tier) postdated “add content” and “delete content” requests up to the requested date and determine, as in step 525, whether the requested tier is projected to have sufficient storage space available on that date. If insufficient space then the user is notified, such as in step 535. If sufficient space, then the request is preferably acknowledged, as in step 530, and then placed in the postdated request file.

The system keeps track of postdated requests and, when the requested time arrives, takes the appropriate action, such as adding or deleting content. Preferably, existing content is deleted before new content is added so as to avoid insufficient space problems. However, if insufficient space is available for any reason, such as due to a programming error or a mechanical failure, the user and the network operator are preferably both notified so that they can determine the appropriate action to take. Of course, a default option could also be to delete enough existing content, based on some predetermined criteria such as age, demand, size, etc., to make space for the new content and then add the new content. However, even in this case, it is still preferable to notify the user and the network operator of the problem and the action taken.

The CMS 105 also preferably includes a report generator (not shown) through which the network operator or content provider may query the network and generate reports such as a list of the usage of the content files broken down in various ways, such as by network segment, or head-end, region, or library or the activity for a particular VOD server.

For example, a content provider 225 may want to generate a report of its content files in order of subscriber requests by tier. If a content provider 225 finds that a particular content file has a high demand but is in a lower tier, i.e., a tier that is not as widely available to subscribers as a higher tier, the content provider 225 may want to move that particular file to a higher tier. Although the content provider 225 is preferably limited to viewing and accessing files and data related to it, the network operator will preferably have access to all content files and data information. Thus, the network operator may generate queries and reports on the overall system, any aspect thereof, or any content provider 225.

The CMS 105 preferably provides additional tools such as billing interfaces for various billing systems. The RDBMS 210 may use various commercially available RDBMS software such as Oracle™ RDBMS software, and use various platforms or operating systems such as UNIX™ or Windows NT™. Furthermore, the RDBMS 210 does not need to be located near the VOD Servers 115, 120, and 125. For example, the CMS 105 may be located in a computer room remote from any VOD Server 115, 120, and 125. In addition, the network operator and content providers 225 may also be in geographically disparate locations.

The Categorization Information may be changed by manual input, preprogrammed data, or automatic update. If done manually, this is done via a GUI with security management guidelines established by the network operator. If a user has authorization, that user can change the Categorization Information. The ability to change the Categorization Information enables the user to change the price of the content, the availability of the content, the packaging of the content, or like items. As content becomes more widely available or has been released for a longer time, the price may automatically be reduced, automatically be reduced at preprogrammed intervals, or manually reduced. Or, if there is unexpected demand for a piece of content due to unexpected events or publicity, the price of the content may be increased. Packaging could be altered so that content might be made available to a different variety of customers over time. Availability options could be changed with, or independent of, pricing. Thus, a movie might be available during restricted hours or days or the movie might be offered at a special rate, 2 for the price of 1, depending on the categorization. Alternatively, content could be packaged with other related content such as movies and their sequels, content with the same actor, or content that is of the same genre. This makes the Categorization Information for content more dynamic over the life of the content, thus, enabling the network operator, MSO, or content provider to maximize revenue for each item.

By changing Categorization Information, the user can target network usage to maximize efficiency. For example, if it is determined that maximum usage of the video streaming capacity occurs between 7:00 p.m. and 11:00 p.m., the content could be packaged such that subscribers would be motivated to order the content for delivery during off peak times, thereby maximizing video stream usage. Further, by monitoring usage, the user can dynamically determine the most effective packages to achieve predetermined business goals, such as maximized revenue during the term that the content is rented from another source or a studio. Further, alternative packaging could enable more creative content offerings from the content providers.

With changes to the Categorization Information, the VOD system 100 will either immediately or at programmed times (such as late at night when stream processing is lowest) build a new menu with the updated Categorization Information. The menu may be generated as bit-maps or as HTML or XML files that are sent to each subscriber as requested. If as a bit-map, each action by the subscriber is a different bit-map. Alternatively, if the menus are HTML or XML files, they may link to different screens. These alternatives are mentioned as examples, and not limitations for this invention is applicable to any menu generation technique. The updated menu would then reveal the special pricing or packaging options available. Further, if the Categorization Information was different for different subscribers (i.e., a special offer for subscribers within a certain area or with certain characteristics or based upon some other variable) a different menu or subset of menu would be provided for each subset of subscribers. Thus, if subscriber A was entitled to special pricing on movies, then he would view menu A. On the other hand, subscriber B, who was not entitled to the special pricing, would view menu B. Except for the different Categorization Information contained within the menus, the identification information within the menus would appear the same. Further, the subscribers would not necessarily know that they were viewing different menus. The menus can be provided completely independently with each menu comprising a complete set of menu screens or, alternatively, a menu can be generated with different branches for different subscribers. In order to determine what menu or menu branch to send to the subscriber, the VOD system 100 would query the CMS 105 to determine if the subscriber was to receive the particular menu. Alternatively, the authorization system 215 might also be queried as soon as the subscriber moves into the VOD menu and the subsequent menu(s) sent to the subscriber device may be based upon access information maintained in the authorization system. Thus, different menus could be sent to different receiver subscriber devices. Upon purchase of content, the VOD system 100 would send information to the appropriate repository (the CMS 105 or authorization system 215) to ensure that the subscriber would be billed the appropriate amount.

Some factors which might affect the Categorization Information are: the time of day, the day of the week, the month of the year, the date, the age of the content, the amount of time which has passed since the Categorization Information was last changed, a change in the demand for the content, the demand for the content exceeding a predetermined demand, the demand for the content being less than a predetermined demand by a predetermined time, the amount of time which has passed since the content was released, a change in the price of the content, special offers, special promotions, the content order history of the subscriber, the amount of time which has passed since the subscriber last ordered content, purchase of the content by a subscriber within a specified period of time, purchase of other content by a subscriber within a specified period of time, or purchase of related content by a subscriber within a specified period of time.

The prior art use of menus has only one menu or script for the entire system, and does not have any branches for different Categorization Information. In contrast, the present invention provides for multiple menus. If an item of Categorization Information calls for a different menu then a different menu is created for that item of Categorization Information. For example, one item of Categorization Information may be the time of day the content is requested to be provided, and the price may be affected as a result. Therefore, for each different time of day which calls for a different price, a different menu would be created. As another example, another item of Categorization information may be the location of the requester, and the price may be affected as a result. Therefore, for each different requestor location which calls for a different price, a different menu would be created. A plurality of menus is thereby created.

Preferably, the menus and items are interrelated in a tree or branching format. Thus, when the subscriber indicates that the subscriber is interested in some content item, a determination is made as to what location the subscriber is in and, for example, a first menu may be presented which shows the content available in the subscriber's area. The subscriber can then indicate the desired content item, and a second menu is presented which shows the available times for that content item and the price for the content item at those different times. If the user selects one content item and time of day, and then goes on to select a second content item, the menu for the second content item may provide a different price structure for the available times based on the previous purchase of the first content. Thus, a plurality of menus is created in order to accommodate the different subscriber locations, content items, time of day, day of the week, previous purchases, special promotions, etc. Preferably, for convenience and speed, each menu is a bitmapped document. However, if desired, other methods of creating the menus may be used, such as generating the menu on the fly depending upon the user's selections. Also, a menu template may be created, and the appropriate information inserted depending upon the Categorization Information and the user's information and selections.

FIG. 5 also generally indicates the process for modifying the Categorization Information or any of the Identification Information. For example, step 505 represents a request to modify the Categorization Information. However, if the request is authorized per decision 510, then the only remaining step would be to modify the Categorization Information, generally suggested by step 530.

In one embodiment, content Categorization Information is stored in the RDBMS 210, whereas the original content is stored in the disk array 110A. This allows the two to be manipulated independently. In another embodiment, content Categorization Information is stored in the servers 115, 120, 125. In still another embodiment, some content Categorization Information is stored in the RDBMS 210 and other content Categorization Information is stored in the servers 115, 120, 125. Thus, the present invention provides for storing the content Categorization Information in the location or locations desired to provide for speed, redundancy, efficiency, etc. A first set of Categorization Information may be defined, such as availability at a reduced price for a specified time, associated with a particular content file, such as a movie, and sent to one server, such as 125A, for a first set of subscribers. Then, a second set of Categorization Information may be defined, such as availability at a different reduced price for a different specified time or under specified conditions, associated with that same content file, and then sent to another server, such as 125B for a second set of subscribers. Further, as the Categorization Information and the content file are associated, the Categorization Information for one server, such as 125A, can be later modified directly at that server by sending new Categorization Information to that server and specifying that particular content file.

Thus, different subscribers, even in adjacent areas, may view the same movie, but the Categorization Information, such as price, may be different. Further, Categorization Information can be modified at any time, for any server, without affecting the Categorization Information on other servers, and without burdening the System by requiring that the content file be sent again.

This is not possible in current systems where the Categorization Information and the content file are closely linked so that a content file can be associated only with a single set of Categorization Information.

Thus, it will be appreciated that the present invention provides many valuable features and capabilities not available in the prior art. Some, but not all, of these features are the ability to assign tiers of storage space to content providers to use at their discretion, the ability to set criteria to automatically cause the movement of the content within the network, security features, and the ability to modify and/or transmit the Categorization Information without having to send the content. Further, these features and capabilities may be used independently of one another; it is not necessary to implement every feature and capability described herein in order to obtain the benefit of the present invention.

Variations of the present invention will suggest themselves to those of skill in the field upon a reading of the disclosure herein. Therefore, the scope of the present invention is to be determined only by the claims.

1-55. (canceled)

56. A method of managing information related to content on a System, comprising the steps of:
adding promotional information to the identification information associated with the content;
maintaining the identification information, including the promotional information, in a database associated with the System;
changing the promotional information for the content; and
adjusting the availability of the content based on the change in the promotional information.

57. The method of claim 56, wherein the adjusting step comprises adjusting the location of the content among a plurality of storage locations based on the change in the promotional information for the content.

58. The method of claim 56, wherein the adjusting step comprises adjusting the number of copies of the content among a plurality of storage locations based on the change in the promotional information for the content.

59. The method of claim 56, wherein promotional information is at least one of information regarding special offers or information regarding special promotions.

60. The method of claim 56, wherein the step of changing the promotional information comprises storing first promotional information associated with the content for use when a first subscriber desires access to the content, and storing second promotional information associated with the content for use when a second subscriber desires access to the content.

61. The method of claim 56, wherein the step of changing the promotional information comprises storing, in an access authorization system, first promotional information associated with the content for use when a first subscriber desires access to the content, and storing, in the access authorization system, second promotional information associated with the content for use when a second subscriber desires access to the content.

62. The method of claim 56, wherein the step of changing the promotional information comprises automatically changing the promotional information in response to a predetermined event.
